(19) United States
(12) Patent Application Publication
(10) Pub. No.: US 2020/0339364 A1
(43) Pub. Date: Oct. 29, 2020

(54) STOP DEVICE FOR A CONVEYOR SYSTEM

(71) Applicant: FlexLink AB, Göteborg (SE)

(72) Inventors: Sven-Erik ECKERSTRÖM, Hälsö (SE); Michael ÖHMAN, MÖLNDAL (SE)

(21) Appl. No.: 16/753,682

(22) PCT Filed: Sep. 27, 2018
(86) PCT No.: PCT/SE2018/050991

§ 371 Date: Apr. 3, 2020

(30) Foreign Application Priority Data
Oct. 6, 2017 (SE) 1751238-5

(51) Int. Cl. B65G 47/88; F16H 19/00

(52) U.S. Cl. CPC B65G 47/8823; F16H 19/001; B65G 2205/06; B65G 2201/0267; B65G 2205/02; F16H 19/005

(57) ABSTRACT

A stop device for a conveyor system where pallets are conveyed on a transport plane, including a body having a stop surface, where the body of the stop device includes a pivot element including an inclined landing zone and a nose, where the brake device includes a damper element arranged between the pivot element and the body of the brake device, where the stop device includes an actuating means adapted to position the stop device in a stop position in which the nose and the stop surface extends above the transport plane, and where the actuating means is adapted to position the stop device in a bypass position in which the nose and the stop surface are positioned below the transport plane.

### TECHNICAL FIELD

The present invention relates to a stop device for a conveyor system comprising accumulation chains.

### BACKGROUND ART

Conveying devices, such as those which are used for moving objects between different stations in a factory, usually comprise a conveying track in the form of a belt or a chain. The conveying tracks can be recessed in a trench with vertical side surfaces. Alternatively, they can be located on the horizontal upper surfaces of the trench or arranged in some other way. The objects to be conveyed are arranged slidably in relation to the conveying tracks, either directly or via carrying means, which are also known as pallets. A specific type of pallet is a puck, which is a round carrier adapted for smaller and more lightweight objects.

A pallet is conveyed along the conveying device, which comprises different work stations. At a work station, the pallet will be stopped by a stop member such that the operation may be performed on the transported object. In some cases, the object may pass a specific work station without an operation being performed on the object. The stop member may for this reason be arranged to either stop the pallet or to let the pallet pass the work station.

If the conveying device is of a conventional type, in which all work stations are positioned after each other and the operations on the objects are performed synchronous, every pallet will stop at each work station. If no operation is to be performed on an object at a specific work station, the object will have to wait until the operation on the previous object at that work station is ready, until the object can continue. All pallets are in this case released at the same time and moves at the same time. One advantage of such a system is that it is easy to predict the performance of the system. One disadvantage of such a system is that it is not very flexible. If the operation time at a work station is long, all objects will have to wait that time, even if there is no operation performed on all objects. Thus, such systems are mostly used for a single product or when the differences in the products are small.

In other systems, the operations on the objects are performed asynchronous, i.e. the pallet stops at a work station where an operation is to be performed, and is released when the operation is ready. In such systems, a queue comprising a number of pallets may thus be required at at least a few of the work stations in order to compensate for the different through-flow times of the products and for the different operation times at a work station.

In a normal pallet or puck queue, the pallets or pucks are allowed to bump into each other when they reach the end of the queue. A pallet or puck may be provided with a damper or resilient member in order to minimize the forces acting on the pallet or puck when they are stopped. This technology is used on pallets or pucks that convey somewhat heavier objects. For light objects, no additional damping is required.

A stop member is positioned at the work station, where the pallet is to be stopped. For pallets conveying heavy objects, from 10 kg up to over 100 kg and more, a damping means integrated in the pallet may not be enough to reduce the impact from the pallet on the stop member. It is thus of advantage to provide the stop member with a damping means, which may be a hydraulic piston, an elastic component, resilient springs etc. In some cases, it is important that the stop position of the pallet is well-defined. The stop member should for this reason be able to damp the travel of the pallet, i.e. to reduce the speed of the pallet in a controlled way, and at the same time provide an exact stop position. Resilient members are for this reason not practical.

JPH 0616233 A discloses a stop device adapted to stop a conveyed article in a fixed position without giving a shock to the conveyed article. The stop device comprises a stopper arm having a rolling roller arranged on a stopper lever. The stop device comprises a shock absorber adapted to reduce the speed of the conveyed article. The stopper lever allows conveyed articles from the opposite direction to pass the stop device freely.

Most stop members comprise a damper element adapted for a specific weight of the pallet. This type of damper element will perform well for a system comprising pallets that convey the same product all the time. For a system where the pallets convey different products with different weights, the system is not optimal. If the conveyed products are the same for a longer period, the damper element may be adjusted manually, but in a system where different products are conveyed at the same time, some products may be exposed to excessive forces or will not arrive at the exact position due to the wrong properties of the damper element.

There is thus room for an improved stop member.

### DISCLOSURE OF INVENTION

An object of the invention is therefore to provide an improved stop device comprising a brake device for a conveyor system. Another object of the invention is to provide a conveyor system comprising at least one stop device.

The solution to the problem according to the invention is described in the characterizing part of claim 1. Claim 15 contains an advantageous conveyor system. The other claims contain advantageous embodiments and further developments of the stop device.

In a stop device for a conveyor system where pallets are conveyed on a transport plane, where the stop device is adapted to be arranged at the transport plane to either stop a pallet or to bypass a pallet, where the stop device comprises a body having a rotational axis at a first end of the body and a stop surface at a second end of the body, where the stop device comprises an actuating means adapted to position the stop device in a stop position in which the stop device is arranged to stop a pallet, or in a bypass position in which the stop device is arranged to bypass a pallet, the object of the invention is achieved in that the stop device comprises a pivot element arranged between the first end and the stop surface of the body, where the pivot element is arranged pivotable in the body at a first end of the pivot element, where the pivot element comprises a nose arranged at a second end of the pivot element, where the pivot element comprises an inclined landing zone arranged between the first end of the pivot element and the nose, where the stop device comprises a damper element arranged between the pivot element and the body of the stop device, where the nose and the stop surface are adapted to extend above the transport plane in the stop position, and where the nose and the stop surface are adapted to be positioned below the transport plane in the bypass position.

By this first embodiment of the stop device according to the invention, a stop device that can brake a pallet to a low speed before it is stopped is provided. With such a stop device, the stop device can lower the speed of a pallet and thus the impact force from the pallet before the pallet is stopped. This is especially advantageous for heavy pallets conveying heavy objects.

The stop device is provided with a stop position and a bypass position. In the stop position, the stop device will be activated and will brake a pallet that arrives at the stop device before the pallet is stopped. When a pallet arrives at the stop device, a forward support or a rear support of the pallet will hit a landing zone of a pivot element of the stop device. The pallet support will glide on the inclined landing zone and will push it downwards. The stop device is provided with a damper means between the pivot means and the body of the stop device. When a pallet bears on the pivot element, the damper will slowly deflate and at the same time, the speed of the pallet will be reduced. When the damper element is sufficiently deflated, the pallet will be able to continue forwards towards the stop surface of the stop device, but with a significantly reduced speed. The impact on the stop member by the pallet will thus be minimized.

The damper element is adapted to the weight of a pallet with a conveyed object. If different objects are conveyed, the damper is adapted to the heaviest combination of a pallet and an object. Since the damper does not comprise a spring action, and is solely intended to reduce the speed of a pallet, the time for the damper to deflate will depend on the weight of the combination of a pallet and a conveyed object. By adapting the damper to the heaviest combination, it is ensured that the damper will always be able to brake a pallet. With an empty pallet, the deflate time will be somewhat longer, but the speed of the pallet will still be reduced. It is also possible to use a damper element with a progressive damper characteristic.

The stop device comprises an actuating means adapted to position the stop device in either the stop position or the bypass position. The actuating means may be an electric rotating motor, preferably provided with a reduction gear in order to reduce the rotational speed of the motor, or may be a linear actuator of some kind, e.g. an electric or pneumatic actuator. The actuating means will move the stop device from one position to the other position, where the stop device will rotate around the rotational axis of the body. The actuating means is controlled by the control system of the conveyor system.

In one example, the actuating means is further adapted to fine adjust the stop position of the stop device within a predefined interval. The interval is defined from different contact points of the landing zone. At a first end of the pivot element, a lower contact point is defined. When a pallet arrives at the lower contact point, the complete damper element has to be deflated before the pallet support has pressed the nose of the pivot element below the transport plane such that the pallet can continue to the stop surface. At the other end of the pivot element, an upper contact point is defined, close to the nose of the pivot element. When a pallet arrives at the upper contact point, only part of the damper element has to be deflated in order for the pallet to press the nose down below the transport plane.

The lower contact point and the upper contact point defines the interval in which the stop position may be fine adjusted. The fine adjustment of the stop position is preferably made in dependency of the weight of the pallet. For a heavy pallet, the stop position will be adjusted such that the pallet will arrive at the lower contact point. For a lighter pallet, the stop position may be adjusted such that the pallet arrives at a point between the lower contact point and the upper contact point. An empty pallet may arrive at the upper contact point.

The stop device may be positioned in either the stop position or the bypass position when it is idle. It is possible to preload the stop device to this position with a resilient means, such as a spring. The stop device is arranged pivotable on an axle around a rotational axis.

The stop device is arranged on an axle mounted between the right side and the left side of a conveyor, but may also be mounted to one of the conveyor beams. The stop device is mainly intended for heavy-duty conveyor systems comprising accumulation chains as conveying means. In such conveyor systems, an accumulation chain is arranged on each side of the conveyor. The accumulation chains are moved forwards on the conveyor beams, and the pallet bears on the transport rollers of the accumulation chain and is in this manner conveyed forwards by the transport rollers. This type of conveyor is thus adapted for heavy loads of up to 100 kg and more. The stop device is arranged at a predefined sideway position on the axle, in a position where a pallet support will be able to interact with the stop device. A conveyor system may use one or two stop devices to stop a pallet.

The pivot element is preferably mounted to the body of the stop device in a removable manner, such that the pivot element can be replaced if it is worn. Another advantage of a removable pivot element is that the damper can easily be replaced when the pivot element is removed. In this way, different damper elements can be used, depending on the weight of the pallet and the conveyed object. It is thus easy to adapt a stop device for different objects if required.

### BRIEF DESCRIPTION OF DRAWINGS

The invention will be described in greater detail in the following, with reference to the embodiments that are shown in the attached drawings, in which

FIG. 1 shows a stop device according to the invention arranged on a conveyor beam,

FIG. 2 shows a side view of a stop device according to the invention in a stop position,

FIG. 3 shows a side view of a stop device according to the invention during a brake action of a pallet,

FIG. 4 shows a side view of a stop device according to the invention with a stopped pallet,

FIG. 5 shows a side view of a stop device according to the invention in a bypass position,

FIG. 6 shows a side view of a stop device according to the invention with an alternative actuating means, and

FIG. 7 shows a conveyor system comprising a stop device according to the invention.

### MODES FOR CARRYING OUT THE INVENTION

The embodiments of the invention with further developments described in the following are to be regarded only as examples and are in no way to limit the scope of the protection provided by the patent claims. References such as longitudinal, horizontal, vertical, right, left etc. refer to directions of a conveyor in normal use.

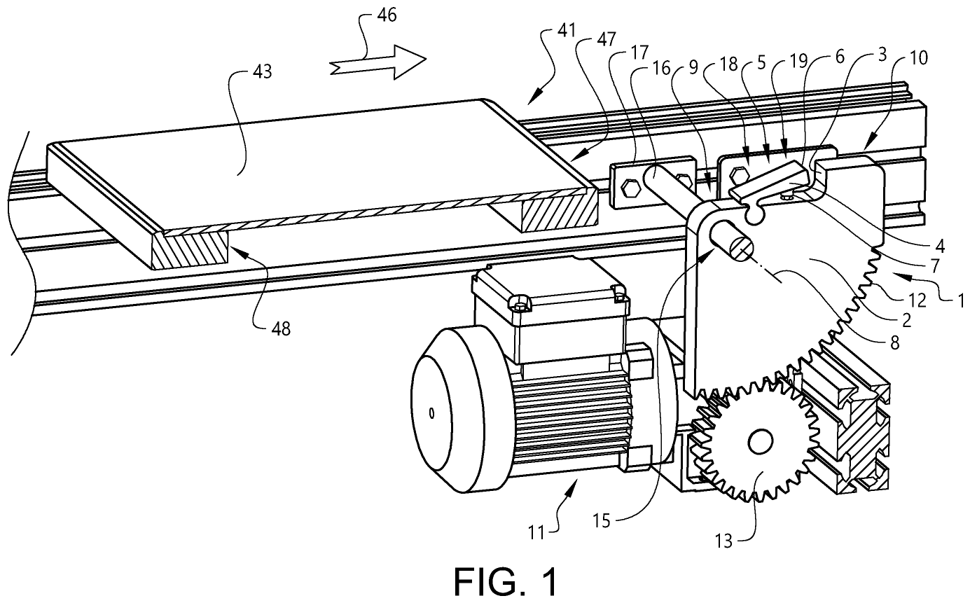

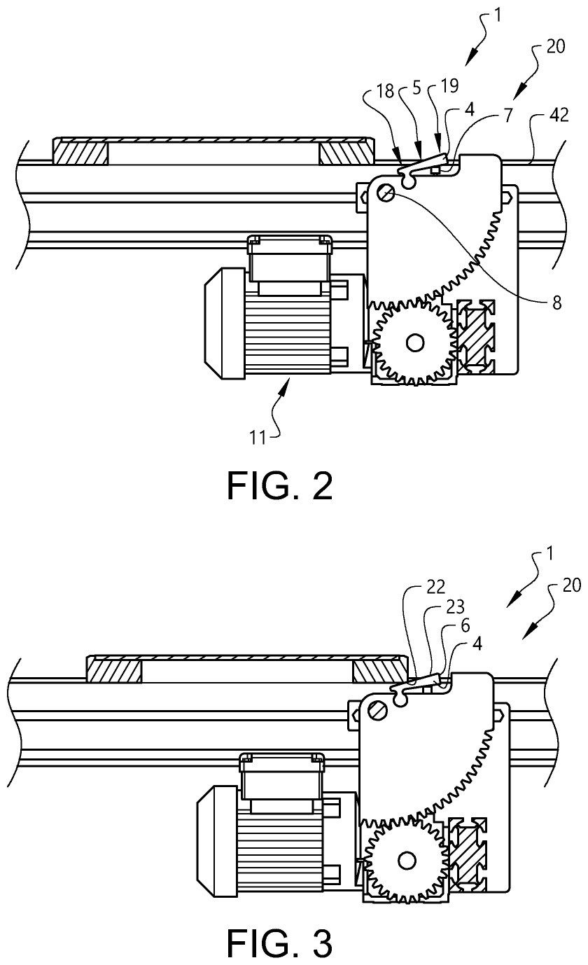

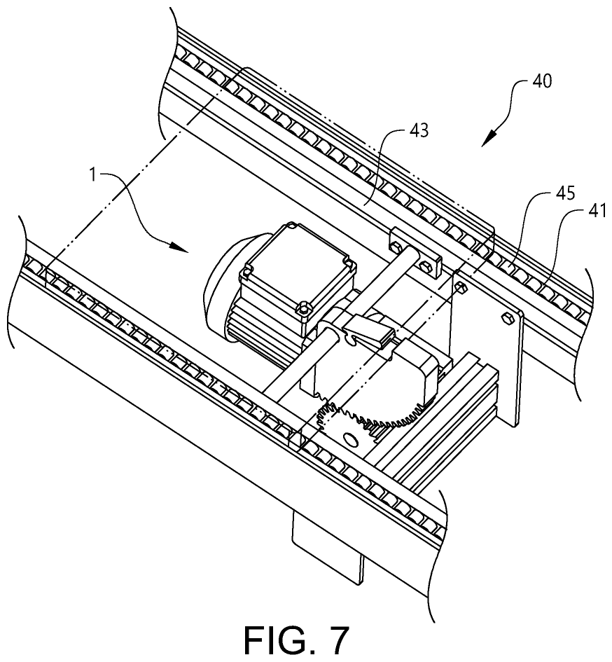

FIG. 1 shows a view of a conveyor 41 with a stop device 1 according to the invention, FIGS. 2 to 6 show details of a stop device, and FIG. 7 shows a conveyor system comprising a stop device. The stop device is primarily intended to be used in conveyor systems adapted for heavy objects, where a loaded pallet may weigh up to 100 kg and more, where the pallet is conveyed by the use of accumulation chains, and where the conveyor system comprises two conveyor beams arranged at each side of the conveyor, each comprising an accumulation chain. An empty pallet may in one example weigh around 20 kg.

The stop device 1 comprises a body 2 having a first end 9 and a second end 10. The body 2 is rigid and made as a single piece. The first end 9 is provided with a rotational axis 8, and the second end is provided with a stop surface 3 adapted to stop and hold a pallet 43 when the stop device is in a stop position 20. The moving direction of the pallet is shown with an arrow 46. The body comprises a hole 15 by which the stop device is mounted on an axle 16. The hole 15 is preferably arranged at the first end of the body 2. The stop device can pivot on the axle, around the rotational axis 8. The stop device is in this example mounted to a conveyor beam by a mounting member 17 to which the axle 16 is fixedly attached. The mounting member is preferably mounted to a channel of the conveyor beam by the use of T-nuts and screws. In this way, it is easy to position the stop device in a desired longitudinal position. The stop device is attached to the axle 16 in a pivotable manner and in a sideways fixed position. When one stop device is used, the stop device will be positioned at the centre of the conveyor, between the conveyor beams where the axle extends between the two conveyor beams. The stop device 1 may e.g. be fixed sideways by the use of a clamp ring or the like. For heavier pallets, it is possible to use two stop devices mounted close to each conveyor beam of the conveyor.

The stop device 1 further comprises a pivot element 4 which is pivotable attached to the body 2. In the shown example, the pivot element is provided with a semi-circular protrusion at a first end 18 of the pivot element, which is attached in a corresponding opening provided at the first end 9 of the body 2. The pivot element 4 may e.g. be held in place on the body by screws and washers. The pivot element comprises a landing zone 5 which is adapted to interact with a pallet support. The landing zone 5 is an inclined surface ending in a nose 6 at a second end 19 of the pivot element. At the second end, a damper element 7 is provided between the body 2 and the pivot element 4. The damper is mounted in a hole in the body 2 and is adapted to damp a downward movement of the pivot element. The damper element is preferably a hydraulic damper provided with oil or air. The damping properties of the damper element 7 can be selected depending on the conveyed load and on the weight of the pallet. The damper element may be adjusted in the stop device or the damper element may be exchanged to a damper element with the required properties. The pivot element 4 will provide a brake function for the stop device, which will reduce the speed of a pallet.

A pallet that is to be stopped by the stop device will arrive at the landing zone 5. In one example, the stop position can be fine adjusted such that the contact point where the pallet support arrives at the landing zone can be selected. The landing zone is provided with a lower contact point 22 which is the first contact point where a pallet can arrive at the landing zone. The landing zone is also provided with an upper contact point 23 that is the last contact point where a pallet can arrive at the landing zone. The lower contact point and the upper contact point defines the interval in which the stop position can be fine adjusted. For a heavy pallet, the lower contact point 22 or a contact point close to the lower contact point 22 may be used. For a light pallet, the upper contact point 23 or a contact point close to the upper contact point 23 may be used. Any position in the interval can be used, depending on the weight of the pallet. A control unit is arranged to control the stop device, and the control unit can receive information about an incoming pallet and fine adjust the stop position accordingly. The pallet may e.g. comprise an RFID-chip that carries information about the weight of the pallet, or the conveyed product comprises an RFID-chip that identifies the product.

The stop device 1 comprises an actuating means 11 adapted to position the stop device in either the stop position 20 or the bypass position 21. The actuating means 11 may be an electric rotating motor, e.g. a DC motor or a stepper motor. The motor may be provided with a reduction gear in order to reduce the rotational speed of the motor. The reduction gear may be a straight transmission or may be a worm gear. Preferably, a self-locking worm gear is used. The actuating means 11 may also be a linear actuator of some kind, e.g. an electric or pneumatic actuator. The actuating means 11 will move the stop device 1 from one position to the other position, where the stop device will rotate around the rotational axis 8 of the body. The actuating means may be controlled by the control system of the conveyor system or may comprises an integrated control unit adapted to communicate with the control system of the conveyor system.

FIG. 2 shows the stop device arranged in a stop position 20. The stop device is arranged pivotable on the axle 16 around the rotational axis 8. The stop device may be provided with a first end stop that defined the stop position 20 and a second end stop that defined the bypass position 21. It is possible to use a resilient element such as a coil spring to position the stop device in the stop position 20 or in the bypass position 21. In another example, the body comprises a groove that is concentric with the hole 15 and which defines the amount of rotation for the stop device. A bolt mounted in the clamp ring extends into the groove and allows the stop device to rotate between the two end stops defined by the groove. In the stop position, the nose 6 of the pivot element 4 and the stop surface 3 of the body will extend above the transport plane 42 of the conveyor. The stop device is adjusted such that the selected contact point of the pivot element is aligned with the transport plane 42.

When a pallet reaches the stop device, the edge of the forward front side 47 or the edge of the rear inner side 48 of the pallet support member will, as is shown in FIG. 3, arrive at the landing zone 5, here at the lower contact point 22. This will temporarily stop or slow down the movement of the pallet, depending on several factors. These include the speed of the conveyor, the weight of the pallet and the damping properties of the damper element. When the pallet stops at the landing zone, the forward force of the pallet will push down the pivot element until the nose 6 is aligned with the transport plane. When the pivot element has been pushed down, the pallet can continue the movement forwards, but with a reduced speed, and will abut the stop surface 3. The stop surface 3 may be straight and aligned such that it is parallel with the forward front side or the inner rear side of the pallet support when the respective surface bears on the stop surface. The stop surface may also be slightly angled or curved such that only the edge of the pallet support will bear on the stop surface. This will make it easier to release a pallet from the pallet stop.

When a light pallet reaches the stop device, the stop device can be fine adjusted in order to take account of the lighter weight. The stop device is in this case fine adjusted such that e.g. the upper contact point 23 is aligned with the transport plane. The edge of the forward front side 47 or the edge of the rear inner side 48 of the pallet support member will in this example arrive at the upper contact point 23 of the landing zone 5. The forward force of the pallet will push down the pivot element until the nose is aligned with the transport plane, but in this example the damper element must only be pushed down partly. The time for braking a light pallet can thus be adapted to the weight of the pallet, and the light pallet can be stopped in a reliable way. In some cases, an empty pallet may not need to be slowed down at all. The stop device may in this case be arranged such that the pivot element is arranged below the transport plane.

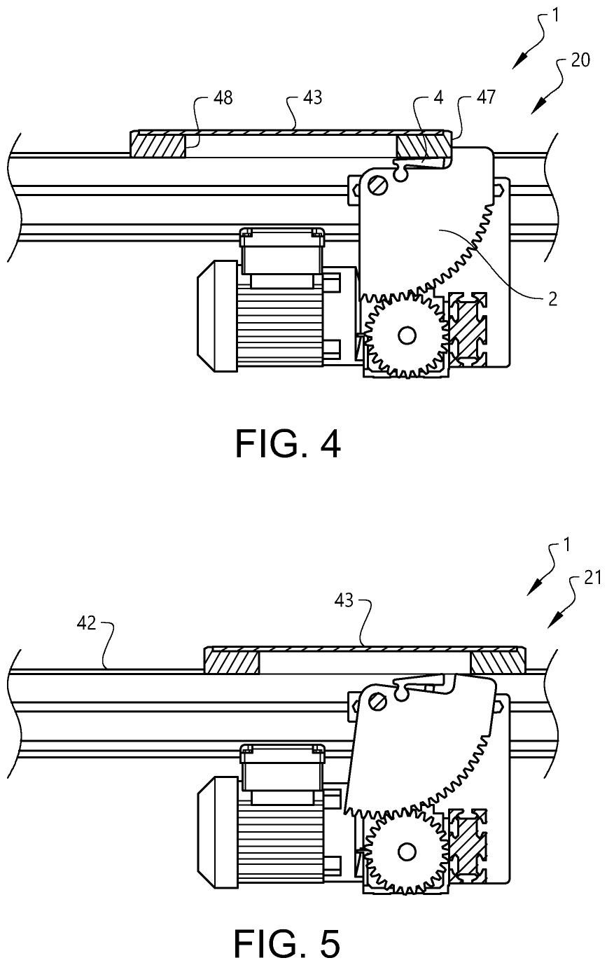

FIG. 4 shows a damper element which is deflated and where a pallet bears on the stop surface 3.

FIG. 5 shows the stop device in the bypass position 21, in which it is adapted to bypass a pallet without stopping it or without reducing the speed of the pallet. The stop device is positioned in the bypass position by the actuating means 11. A second end stop may define the bypass position. In the shown example, the actuating means 11 is a rotating motor provided with a first cogwheel 13. The cog wheel is adapted to cooperate with teeth 12 provided at the body of the stop device. In one example, the body comprises a part-circular section provided with teeth at the circumference of the body adapted to directly cooperate with the teeth of the cogwheel. The motor is preferably provided with a reduction gear. The reduction gear may also be provided with a rotational detector such that the stop position and the bypass position can be defined in an easy way, and such that the fine adjustment of the stop position can be made. It is also possible to use a first end stop and a second end stop to define the stop position and the bypass position, and to measure the motor current to stop the motor at the defined positions. The teeth of the body and the cogwheel of the motor may also be realized as a worm gear.

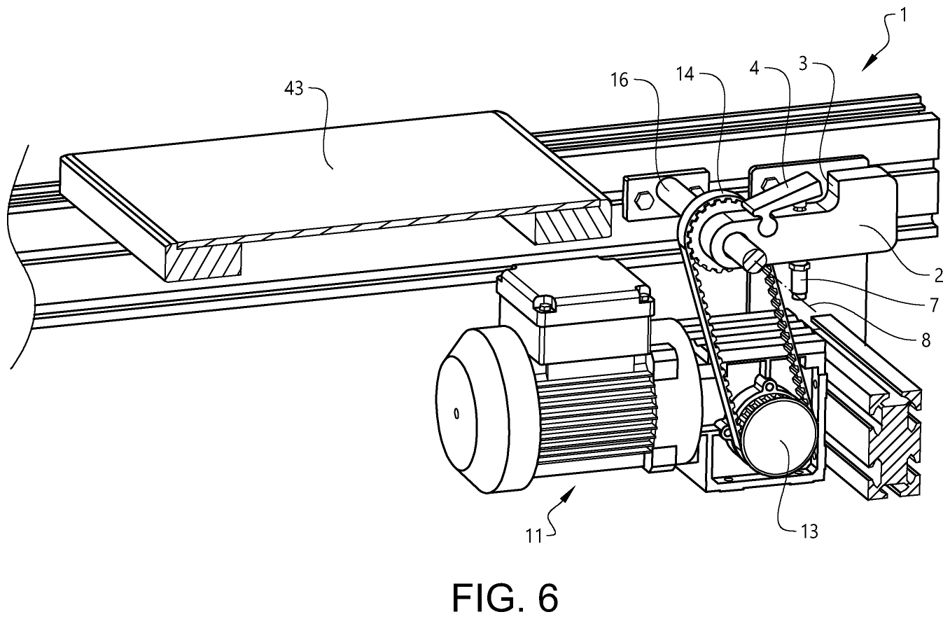

FIG. 6 shows an alternative actuating means 11 where a second cogwheel 14 is provided at the rotational axis of the body. The second cogwheel may be integrated with the body or may be attached to the body, and rotates around at the same rotational axis as the body. The first cogwheel may mesh directly with the second cogwheel, or may act on the second cogwheel through a belt or chain. In the shown example, a toothed belt is used to connect the first cogwheel to the second cogwheel.

It is also possible to use a linear actuator (not shown), such as a pneumatic cylinder or an electric actuator, as the actuating means. Such an actuating means can be controlled between the stop position and the bypass position, and may provide one or more different contact points at the stop position. The linear actuator will in one example act on the lower side of the body. A linear variable electric actuator can be controlled by an electronic control unit in order to fine adjust the stop device in the stop position. It is also possible to use two pneumatic linear actuators connected in series. One linear actuator may have a relatively long stroke and is adapted to move the stop device between the stop position and the bypass position. The other linear actuator may have a relatively short stroke and is adapted to fine adjust the stop device in the stop position, such that two different contact points of the landing zone can be used. A solution with two pneumatic cylinders will be a very cost-effective solution, and will allow pallets of different weights to be stopped in a reliable way.

FIG. 7 shows a conveyor system 40 comprising a stop device 1 arranged at e.g. a work station. The conveyor system comprises two parallel conveyor beams 41. An accumulation chain 45 is arranged in each conveyor beam. The axle supporting the stop devices is attached to the two conveyor beams. A first pallet is stopped by the stop device after the speed has been reduced by the brake function of the stop device. The stop device is controlled by the control system of the conveyor system. A second pallet will bear on the first pallet and may be slowed down by a separate brake element. In this way, a simple and cost-effective stop function for a pallet is obtained.

The invention is not to be regarded as being limited to the embodiments described above, a number of additional variants and modifications being possible within the scope of the subsequent patent claims. The stop device may have any size and may be made from any suitable material.

### REFERENCE SIGNS

1: Stop device
2: Body
3: Stop surface
4: Pivot element
5: Landing zone
6: Nose
7: Damper element
8: Rotational axis
9: First end of body
10: Second end of body
11: Actuating means
12: Teeth
13: First cogwheel
14: Second cogwheel
15: Hole
16: Axle
17: Mounting member
18: First end of pivot element
19: Second end of pivot element
20: Stop position
21: Bypass position
22: Lower contact point
23: Upper contact point
40: Conveyor system
41: Conveyor
42: Transport plane
43: Pallet
44: Pallet support member
45: Accumulation chain
46: Moving direction
47: Forward front side
48: Rear inner side

1. A stop device for a conveyor system where pallets are conveyed on a transport plane, wherein the stop device is adapted to be arranged at the transport plane to either stop a pallet or to bypass a pallet, where the stop device comprises a body having a rotational axis at a first end of the body and a stop surface at a second end of the body, wherein the stop device comprises an actuating means adapted to position the stop device in a stop position in which the stop device is arranged to stop a pallet, or in a bypass position in which the stop device is arranged to bypass a pallet, wherein the stop device comprises a pivot element arranged between the first end and the stop surface of the body, where the pivot element is arranged pivotable in the body at a first end of the pivot element, where the pivot element comprises a nose arranged at a second end of the pivot element, where the pivot element comprises an inclined landing zone arranged between the first end and the nose, where the stop device comprises a damper element arranged between the pivot element and the body of the stop device, wherein the nose and the stop surface are adapted to extend above the transport plane in the stop position, and wherein the nose and the stop surface are adapted to be positioned below the transport plane in the bypass position.

2. The stop device according to claim 1, wherein the first end of the pivot element is adjacent the rotational axis.

3. The stop device according to claim 1, wherein the actuating means is adapted to fine adjust the stop device in the stop position within a predefined interval.

4. The stop device according to claim 3, wherein the stop position is adjusted in the predefined interval depending on the weight of a pallet that is to be stopped.

5. The stop device according to claim 1, wherein the body of the stop device is adapted to pivot around the rotational axis from the stop position to the bypass position.

6. The stop device according to claim 1, wherein the actuating means is a linear actuator having a first extended end position adapted to position the stop device in the stop position, and a second retracted end position adapted to position the stop device in the bypass position.

7. The stop device according to claim 6, wherein the linear actuator is a variable electric actuator or a pneumatic cylinder having more than two positions.

8. The stop device according to claim 1, wherein the actuating means is a rotating motor adapted to position the stop device in the stop position or in the bypass position.

9. The stop device according to claim 8, wherein the body is provided with teeth adapted to cooperate with a corresponding first cogwheel of the motor.

10. The stop device according to claim 9, wherein the teeth are provided at a circumferential surface of the body.

11. The stop device according to claim 10, wherein the first cogwheel is adapted to mesh directly with the teeth.

12. The stop device according to claim 9, wherein the teeth are provided on a second cogwheel mounted to the body at the rotational axis.

13. The stop device according to claim 12, wherein the second cogwheel is adapted to mesh with the first cogwheel through a belt or a chain.

14. The stop device according to claim 1, wherein the stop device is provided with a resilient means adapted to preload the stop device to the bypass position.

15. A conveyor system adapted to convey pallets on a transport plane, comprising a conveyor and at least one accumulation chain, wherein the conveyor system comprises at least one stop device for the conveyor system where pallets are conveyed on a transport plane, wherein the stop device is adapted to be arranged at the transport plane to either stop a pallet or to bypass a pallet, where the stop device comprises a body having a rotational axis at a first end of the body and a stop surface at a second end of the body, wherein the stop device comprises an actuating means—adapted to position the stop device in a stop position in which the stop device is arranged to stop a pallet, or in a bypass position in which the stop device is arranged to bypass a pallet, wherein the stop device comprises a pivot element arranged between the first end and the stop surface of the body, where the pivot element is arranged pivotable in the body at a first end of the pivot element, where the pivot element comprises a nose arranged at a second end of the pivot element, where the pivot element comprises an inclined landing zone arranged between the first end and the nose, where the stop device comprises a damper element arranged between the pivot element and the body of the stop device, wherein the nose and the stop surface are adapted to extend above the transport plane in the stop position, and wherein the nose and the stop surface are adapted to be positioned below the transport plane in the bypass position.
